(19) United States
(12) Patent Application Publication
(10) Pub. No.: US 2017/0200390 A1
(43) Pub. Date: Jul. 13, 2017

(54) EDUCATIONAL SYSTEM UTILIZING A CONTEST AND A METHOD OF CONDUCTING THE SAME

(71) Applicant: Arthur E. Seymour, Deerfield, IL (US)

(72) Inventor: Arthur E. Seymour, Deerfield, IL (US)

(21) Appl. No.: 15/379,518

(22) Filed: Dec. 15, 2016

Related U.S. Application Data
(60) Provisional application No. 62/275,870, filed on Jan. 7, 2016.

(51) Int. Cl. G09B 19/00; A63H 33/04; G09B 5/02; A63H 33/08

(52) U.S. Cl. CPC G09B 19/00; A63H 33/08; A63H 33/042; G09B 5/02

(57) ABSTRACT

An educational system utilizing a contest and a method of conducting the same is provided. The educational system and contest may utilize: 1) various objects and stories provided for in electronic and/or book form wherein an individual may participate in the creation and adaptation of the objects and stories; 2) various computer codes for Internet interaction between an individual and a computer program and/or other individuals related to the stories; 3) a plurality of building blocks; 4) electronic circuit paths for providing sound and movement to the plurality of building blocks; and 5) a voting system for providing awards based on the creation/adaptation of the stories and objects. The plurality of building blocks, when assembled correctly may create a functional QR Code. The individual may also submit his/her creation to a website which may allow for votes and prizes.

### CROSS REFERENCE TO RELATED APPLICATION

The following application is a based on and claims the priority benefit of U.S. Provisional Application Ser. No. 62/275,870 filed on Jan. 7, 2016 currently co-pending; the entire contents of which are incorporated by reference.

### BACKGROUND OF THE INVENTION

An educational system utilizing a contest and a method of conducting the same is provided. The educational system and contest may utilize: 1) various objects and stories provided for in electronic and/or book form wherein an individual may participate in the creation and adaptation of the objects and stories; 2) various computer codes for Internet interaction between an individual and a computer program and/or other individuals related to the stories; 3) a plurality of building blocks; 4) electronic circuit paths for providing sound and movement to the plurality of building blocks; and 5) a voting system for providing awards based on the creation/adaptation of the stories and objects. As the individual builds functional physical objects out of the building blocks and adapts the same, the individual may learn information about animals, geology, the oceans, outer-space, or other scientific topics. The plurality of building blocks, when assembled correctly create a functional QR Code. Once completed, the individual may electronically submit (via photographs and/or computer generated images) his/her creation to a website wherein other individuals, including their peers, may vote and award prizes and recognition. A single “vote” code may be included in a single box containing a plurality of blocks for building one of the objects.

Patents have been granted for unique teaching methods. For example, U.S. Pat. No. 5,551,878 to Ellenbogen discloses ways of improving writing skills through the use of an associative letter writing template comprising stationery having distinct regions separable by perforations. One distinct region has an outline of a letter while another distinct region has a plurality of thematic markings. The thematic markings may include words grouped by sub-topic and/or illustrations relating to a common theme.

Further, U.S. Pat. No. 6,859,211 to Friedlander discloses a system and method for generating an interactive story comprising a system that prompts an individual with a image or photograph and provides a set of active and descriptive words relating to the picture, as well as a set of predetermined, commonly-used parts of speech and phrases, including articles, verbs, prepositions, and conjunctives. The user is instructed to write an essay, short story, letter or poem online employing only said given set of active and descriptive words relating to the common picture. The completed textual work may then be submitted to a contest or posted for others to read and critique.

Still Further, U.S. Pat. No. 7,261,612 to Hannigan discloses pages of a children's book marked in a machine-readable manner (e.g., by imperceptible digital watermark technology). When such a page is shown to a camera-equipped computer device, the watermark is decoded, and the story text from that page is read aloud to a child. A number of variants are contemplated, including using book pages as entry points to corresponding videos; using books to link to corresponding interactive web sites or multi-player games; incorporating the camera in a plush toy; evoking different responses from the system by using the book to convey gestures to the camera; providing such functionality in cell phones, set top boxes, and Bluetooth-equipped devices; customizing read-aloud stories using words provided by the child or a parent; etc.

However, the previously identified patents fail to provide an educational system utilizing a contest and a method of using the same which is easy to use and highly effective as in the present method. Further, these previous patents fail to disclose an educational system utilizing a contest and a method of using the same in which individuals create physical objects out of blocks. A need therefore exists for an improved educational system utilizing a contest and a method of using the same.

There is an archaic process for providing education, such that we are given information, are not able to use or apply it immediately, and expected to retain what we have been given and know how to apply it later in life. Even before the information is given, the education process sets goals or objectives for what is expected to be retained. Then information is usually provided in a very formal and unexciting manner. An evaluation of how well we retained the information is often obtained by giving an examination or quiz shortly after the information is provided. For the most part these examinations only test short-term memory.

Information in many cases is provided to the learner through various educational methods. Typically, the student has a textbook or other material to read. Also lectures, explaining the material, are conducted. With online learning, that lecture may be in the form of a video. Computers in Libraries can easily network and share not only with presenters and attendees but with prerecorded videos that are nothing more than massive information exchanges. There also exist expensive schoolrooms and teachers for personal instruction to give the student a chance to ask for clarification or more details. These processes rarely excites a student and often makes them not want to participate especially when they are lost and do not want to appear inept in front of their peers or other participants.

Taking phones and electronic tablets from students instead of using them to enhance learning is obsolete. The time has come to celebrate the technology students have and use these as learning tools. Phones and electronic tablets are no longer just devices to play games on and make phone calls . . . when they were, then banning them was OK. Today there is more processing power in the average cellular telephone than NASA had access to when they sent a man to the moon in 1969. Yet most students only know how to use these devices for social media and playing games. The time has come to show our students the learning possibilities and turn these devices into exciting learning opportunities that will reach far outside the classroom and into the pockets and backpacks of creative minds.

Recently, exciting stories and movies have stimulated reading and memory of fictional characters that use magic. Using the technology described above, and proper demonstration of how the real world is filled with its own type of magic in the Arts and Sciences will create long term memory in both of these fields. This will also create an excitement to learn more in the Arts and Sciences, an emotion that is definitely lacking in the majority of our educational systems today. “Wisdom begins with wonder.” Socrates.

QR code (abbreviated from Quick Response Code) is the trademark for a type of matrix barcode (or two-dimensional barcode) first designed for the automotive industry in Japan. A barcode is an optical machine-readable representation of data relating to the object to which it is attached. Originally barcodes systematically represented data by varying the widths and spacing of parallel lines, and may be referred to as linear or one-dimensional (1D). Later they evolved into rectangles, dots, hexagons and other geometric patterns in two dimensions (2D). Although 2D systems use a variety of symbols, they are generally referred to as barcodes as well. Barcodes originally were scanned by special optical scanners called barcode readers. Later, scanners and interpretive software became available on devices including smartphones and iPods. The QR Code system became popular outside the automotive industry due to its fast readability and greater storage capacity compared to standard UPC barcodes. Applications include product tracking, item identification, time tracking, document management, and general marketing.

A QR code consists of modules (square dots) arranged in a square grid on a contrasting background, which can be read by an imaging device (such as a camera, scanner, etc.) and processed using Reed-Solomon error correction until the image can be appropriately interpreted. The required data are then extracted from patterns that are present in both horizontal and vertical components of the image. Now the inventor of the QR Code has allowed the patents for the code to be freely available to the public. Consequently, many websites now feature online QR Code generators or downloadable code-generating software.

Although initially used to track parts in vehicle manufacturing, QR codes are now (as of 2012) used over a much wider range of applications, including commercial tracking, entertainment and transport ticketing, product/loyalty marketing (examples: mobile couponing where a company's discounted and percent discount can be captured using a QR code decoder which is a mobile app, or storing a company's information such as address and related information alongside its alpha-numeric text data as can be seen in Yellow Pages directory), and in-store product labeling. It can also be used in storing personal information for use by organizations. An example of this is Philippines National Bureau of Investigation (NBI) where NBI clearances now come with a QR code. Many of these applications target mobile-phone users (via mobile tagging). Users may receive text, add a vCard contact to their device, open a URI, or compose an e-mail or text message after scanning QR codes. They can generate and print their own QR codes for others to scan and use by visiting one of several pay or free QR code-generating sites or apps. QR codes storing addresses and URLs may appear in magazines, on signs, on buses, on business cards, or on almost any object about which users might want information. Users with a camera phone equipped with the correct reader application can scan the image of the QR code to display text, contact information, connect to a wireless network, or open a web page in the telephone's browser. This act of linking from physical world objects is termed hardlinking or object hyperlinking. QR codes have been used and printed on train tickets in China since 2010. Recruiters have started placing QR codes in job advertisements, while applicants have started sporting it in their CVs and visiting cards.

In June 2011, The Royal Dutch Mint (Koninklijke Nederlandse Munt) issued the world's first official coin with a QR code to celebrate the centenary of its current building and premises. The coin can be scanned by a smartphone and link to a special website with contents about the historical event and design of the coin. In 2014, the Central Bank of Nigeria issued a 100-naira banknote to commemorate the centennial of its existence. It is the first banknote to incorporate the QR code into its design. When scanned with an internet-enabled mobile device, the code goes to a website which tells the centenary story of Nigeria. In 2008, a Japanese stonemason announced plans to engrave QR codes on gravestones, allowing visitors to view information about the deceased, and family members to keep track of visits.

Psychologist Richard Wiseman was one of the first authors to include QR Codes in a book, in Paranormality: Why We See What Isn't There (2011), allowing his readers to follow-up on paranormal claims by accessing his research through the codes.

None of the above, however, uses a QR code in an exciting story that encompasses an educational toy to motivate and teach the Arts and Sciences. The final goal of this process is to create the desire in the student or user to compete to receive beneficial and desirable awards in a contest. This invention will thus motivate a desire to create even more educational tools and inspire others to engage in the Arts and Sciences.

### SUMMARY OF THE INVENTION

An educational system utilizing a contest and a method of conducting the same is provided. The educational system and contest may utilize: 1) various objects and stories provided for in electronic and/or book form wherein an individual may participate in the creation and adaptation of the objects and stories; 2) various computer codes for Internet interaction between an individual and a computer program and/or other individuals related to the stories; 3) a plurality of building blocks; 4) electronic circuit paths for providing sound and movement to the plurality of building blocks; and 5) a voting system for providing awards based on the creation/adaptation of the stories and objects. As the individual builds functional physical objects out of the building blocks and adapts the same, the individual may learn information about animals, geology, the oceans, outer-space, or other scientific topics. In some instances the plurality of building blocks, when assembled correctly create a functional QR Code. Once completed, the individual may electronically submit (via photographs and/or computer generated images) his/her creation to a website wherein other individuals, including their peers, may vote and award prizes and recognition. A single “vote” code may be included in a single box containing a plurality of blocks for building one or more of the objects.

The present teaching method generally provides an educational system with a contest that implements the melding of the Arts and Sciences. More specifically, when an individual purchases a physical product box provided for by the present system, the physical product box may come with a chapter of an exciting story and a plurality of construction type elements (such as building blocks). The individual may also be provided with instructions on how to build some of the objects described in the story out of the provided for building blocks. In an embodiment, the instructions may further provide for or require some artistic adaptation of the objects by the individual by, for example, leaving some portions of the instructions unspecified. The building and/or modification of the objects promote educational value and practice in the Arts. The objects and information in each chapter may also lead the individual (or ‘reader’, or “user” or “student) to willingly want to investigate other similar Art, Scientific, Logic, and Mathematical fields on the Internet using the QR codes provided for in the story.

In an embodiment, the products that contain the chapters of the full story (or ‘novelette’) may be individually purchased in a random fashion. The chapters in the novelette may be similar to independent entries in a diary and may not be dependent upon any other chapter. A ‘novelette’ is often defined by many award contests as a work of fiction of between 7,500 and 17,500 words. Contests such as, Hugo Award for Best Novelette, Locus Awards, Nebula Awards, and Shirley Jackson Awards are given for best Science Fiction and judged only on the writing skills of the contestants. If each novelette is divided into ten chapters then the chapter size should be between 750 and 1750 words. This would also require that approximately ten different physical product boxes, each containing a chapter, would be available for purchase in order to obtain the standard size of a complete novelette.

The present education system may have:

A Customer Identification Number (ID)

Each physical product box containing a chapter may contain a unique customer ID. The customer ID will not be repeated in any other physical product box so to insure the ID is truly unique and the only one in existence. The unique customer ID provided for in each product may be used to cast a vote (or votes) on a website for the individual's favorite story and/or objects electronically submitted by other users of the system in a contest setting. This unique secure customer ID to identify that the user is valid, may be easy to enter and follow the rules listed here;
1. All customer IDs contain only combinations of Capitol letters and numbers.
2. Customer IDs will use a defined number of characters, for now 11.
3. All letters entered will be case insensitive, a=A.
4. Any letters similar in appearance to numbers are avoided, namely I, O, S & Z.
5. The customer IDs will be unpredictable and random.
6. A very large number of customer ID's available.
7. All customer IDs will be unique—there cannot be repeats.
8. The first and last two characters in the ID will identify the chapter and novelette respectively.

The unique customer ID may allow the individual (or ‘student’ or ‘product user’) to enter an educational Internet website that may provide additional information about that chapter or the overall story in further detail and may further link the user to other educational sites explaining the objects in that chapter. This Internet website may offer suggestions on building artistic objects and may further show how these objects may be related to the real world and Sciences that explain the real-world objects. For example, a robot figure made from, for example, toy construction bricks with eyes that glow may be modified to change the color of the robots eyes. In the process, the individual thus learns about electronic paths and electronic components that produce light. A QR code link on the website may further show the robots which were made by NASA or other robotic sites on the Internet showing real robots made by companies in the world today. Because the first and last characters in the unique customer ID identifies the chapter and novelette, the website entered using that unique customer ID may be dedicated to a specific novelette chapter and the objects in that chapter. For example, an ID such as 3xxxxxxxx0B, where x=any allowable number or letter would represent the chapter numbered 3 in the novelette 0B. Because chapters will only have names and can be purchased in any order the number 3 is translated on the Internet site to the proper chapter name and displayed back to the user by name.

Once a valid customer ID is entered by the individual, the individual may have the options to study the educational details for that chapter, enter a contest for creating a new chapter, review entries already entered by other users, and eventually vote for their favorite entry for that chapter submitted by other individuals. Each eleven-character ID is a unique number in a group of over 1,531 trillion possible numbers. A very secure third party will hold valid IDs. ID entry will be checked to prevent automatic entry from another computer. These cautions are taken to insure students and users have a fair voting system and are judged only by their peers.

Education Details Option

When the customer ID number is entered, it may bring the individual to an option page. If, in this embodiment, the Educational details option is chosen, the chapter corresponding to the first alpha-numeric character of the customer ID number in the novelette corresponding to the last two alpha-numeric characters of that customer ID number may be opened to the individual. In this section of the Internet website, all the Art forms in that chapter may be discussed and links to real world Sciences related to those Art forms may be available and discussed. For example, if the first object to be constructed were, for example, a robot with eyes that light up then the electronic circuit path that makes the light for the eyes would be explained in detail with analogies and animated videos to improve understanding.

Links to other robot sites showing similar Art forms may be provided and explained on the website in the present system. Further, links to robot clubs and real robots made by NASA and others may also be provided and discussed. A definition of each type of robot and details of their invention may also be provided. Besides electronics, mechanics, physics, chemistry (battery life), astronomy, mathematics, speech recognition and generation, and social studies (picking a robotic voice), other user added real world sciences might be added by the student or user if approved. This would be for just the first paragraph in the chapter. An index may be added to help the individual move through all the above quickly and see how that field was used in developing the story and Art form. Movement back to the novelette at any time would be one simple button. The exciting stories and above educational details is intended to excite users into investigation of many different fields in the Arts and Sciences that are part of the exciting story.

Contest Review Options

If, in an embodiment, the contest option is chosen by the individual, the rules for writing a new chapter in this novelette may be listed on the website. All requirements and details for presenting an acceptable entry may also be provided. Help sites may be available to inspire and motivate authors of all age levels. Before approval, all entries may be studied to ensure there are no violations to any intellectual property rights or copyrights. A legal disclaimer may be required and must be signed by individual contestant. All entries already approved may be available for review by age groups at separate site pages. Author's identity will be completely hidden and protected by the customer ID. These same review pages will be used for voting when that option is allowed. Acknowledge of acceptance and email letter of compliance will be sent back to the individual showing voting schedules for each age group with dates and location for award presentations.

Voting Options

If, in an embodiment, the voting option is chosen, the unique customer ID will be required to enter the proper review pages. An age category must then be selected to review only the proper age group. Selecting the chapter desired will activate a vote for button that may require a two-step process, vote and verify, to prevent an accidental vote. The choice will be recorded in the computers of a third party legal firm that may keep results hidden until the actual awards are given. The unique ID number may be tagged as used and unavailable to cast another vote. An email acknowledgment may be sent showing selected chapter and age group voted for to the user that just voted. By allowing customers to vote on their favorite submissions by other customers, the voting process can therein force the customers (students) to learn about the various other projects submitted by other customers and therein, the customer learns about the Arts and Sciences without the need for formalized tests, text books or formal classrooms.

Awards

In this embodiment, when the voting period starts, the individuals may register their choices for the best chapter rewrite with the best Artistic objects and best Science links or descriptions. The votes may be counted and a winner in each chapter for each age level may be the submitted entry that receives the greatest number of votes. Awards will be given and recorded at an awards presentation that could be transmitted live on social media or other commercial media.

In another embodiment the products containing unique customer ID numbers may be given to a group of individuals to compete on a specified level and wherein the individuals may be judged by qualified preselected group for best entry on that level. The customer ID numbers may be used only to hide the individual's identity and name. Awards are determined by the judging group or group sponsoring that level of competition.

In another embodiment the overall best entries as judged by all individuals of every age group on a complete novelette is presented to the proper contacts to make a video or animated movie from the winning novelette.

An advantage of the present educational system utilizing a contest and method of using the same is that the present educational system and method allows an individual to learn in a quick, fun and efficient manner.

Another advantage of the present educational system utilizing a contest and method of using the same is that the present educational system and method may be used in a building with limited space.

Yet another advantage of the present educational system utilizing a contest and method of using the same is that the present educational system and method may teach individuals of different levels efficiently.

And another advantage of the present educational system utilizing a contest and method of using the same is that the present educational system and method incorporates the individual's personal interests into the learning process.

Yet another advantage of the present educational system utilizing a contest and method of using the same is that the present educational system and method may motivate individuals to learn subjects of interest to them.

For a more complete understanding of the above listed features and advantages of the present educational system utilizing a contest and a method of using the same, reference should be made to the following detailed description of the preferred embodiments. Further, additional features and advantages of the present invention are described in, and will be apparent from, the detailed description of the preferred embodiments and from the drawings.

### BRIEF DESCRIPTION OF THE DRAWINGS

FIG. 1 illustrates a block diagram of the educational system.

FIG. 2 illustrates the individual chapters of the story (‘novelette’) in an embodiment.

FIG. 3 illustrates an embodiment of a website utilizing the system.

FIG. 4 illustrates a unique ID and key convertor in an embodiment.

FIG. 5 illustrates a flow chart path to awards for the contest portion of the system in an embodiment.

FIG. 6 illustrates an embodiment of the awards of the system in an embodiment.

FIG. 7 illustrates an embodiment of an object of the system, in this case a robot.

FIG. 8 illustrates a Quick Response (QR) Code of the present system in an embodiment.

FIG. 9 illustrates an embodiment of a front of a puzzle-picture on a wall in one embodiment.

FIG. 10 illustrated exploded view of the front of the puzzle-picture on a wall in one embodiment.

FIG. 11 illustrates a perspective view of the back of a fully assembled and functional QR Code created on the individual blocks of the puzzle-picture wall when the wall is assembled in an embodiment of the present system.

### DETAILED DESCRIPTION OF THE PREFERRED EMBODIMENTS

An educational system utilizing a contest and a method of conducting the same is provided. The educational system and contest may utilize: 1) various objects and stories provided for in electronic and/or book form wherein an individual may participate in the creation and adaptation of the objects and stories; 2) various computer codes for Internet interaction between an individual and a computer program and/or other individuals related to the stories; 3) a plurality of building blocks; 4) electronic circuit paths for providing sound and movement to the plurality of building blocks; and 5) a voting system for providing awards based on the creation/adaptation of the stories and objects. As the individual builds functional physical objects out of the building blocks and adapts the same, the individual may learn information about animals, geology, the oceans, outer-space, or other scientific topics. The plurality of building blocks, when assembled correctly may create a functional QR Code. Once completed, the individual may electronically submit (for example, with photographs and/or computer generated images) his/her creation to a website wherein other individuals, including their peers, may publicly view the creation and may vote and award prizes and recognition. A single “vote” code may be included in a single box containing a plurality of blocks for building one of the objects.

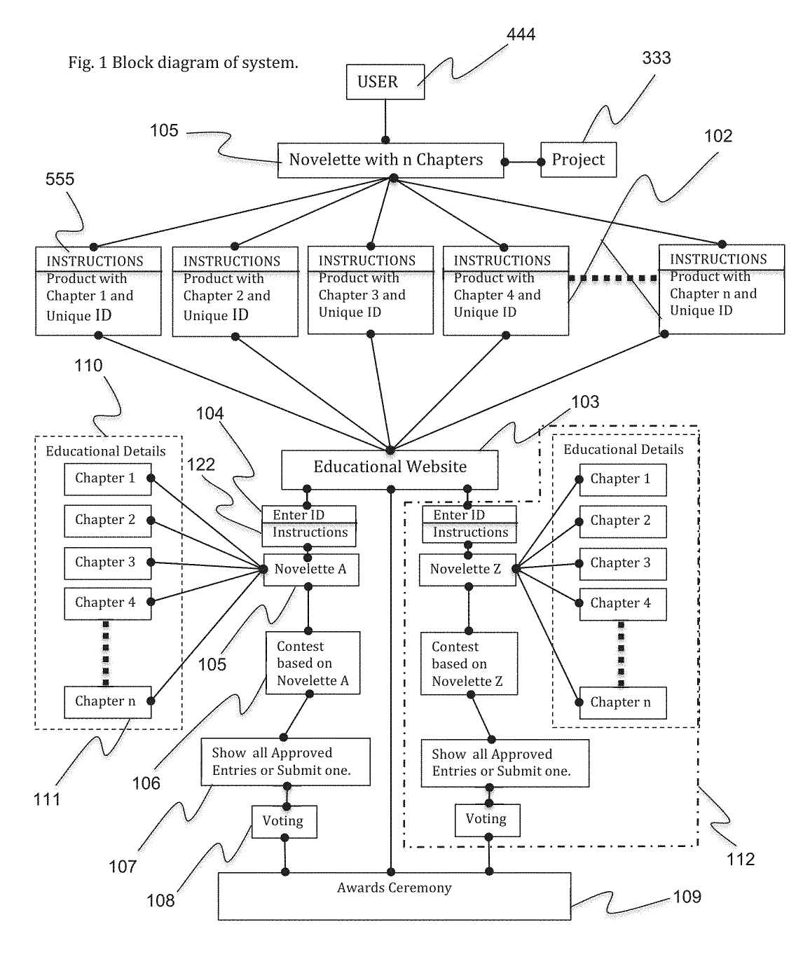

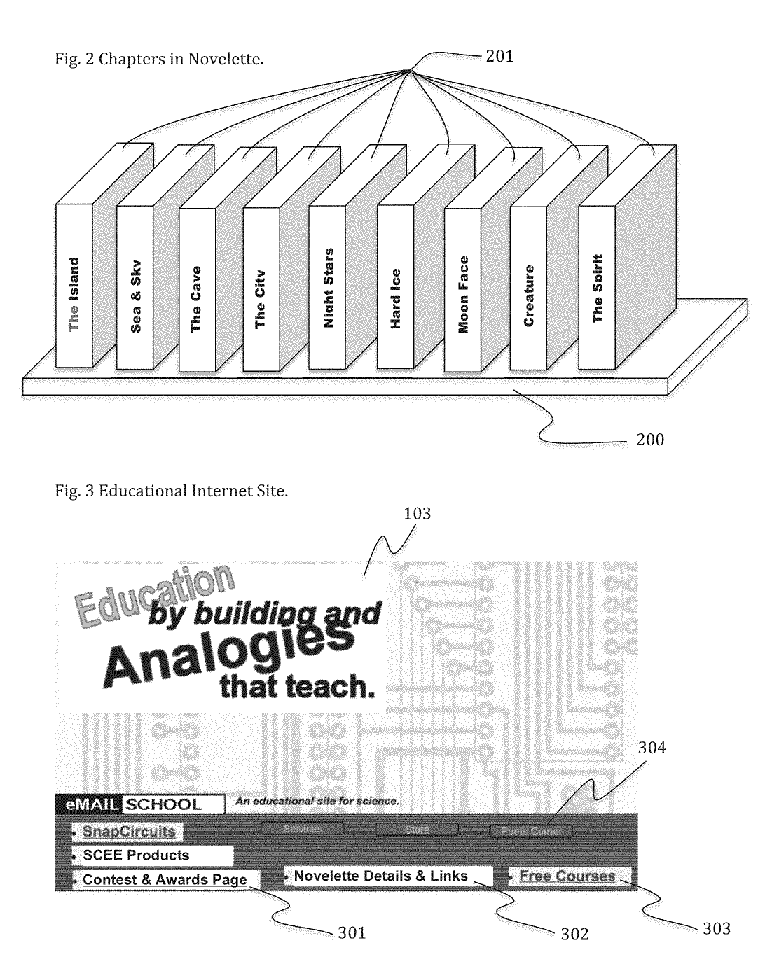

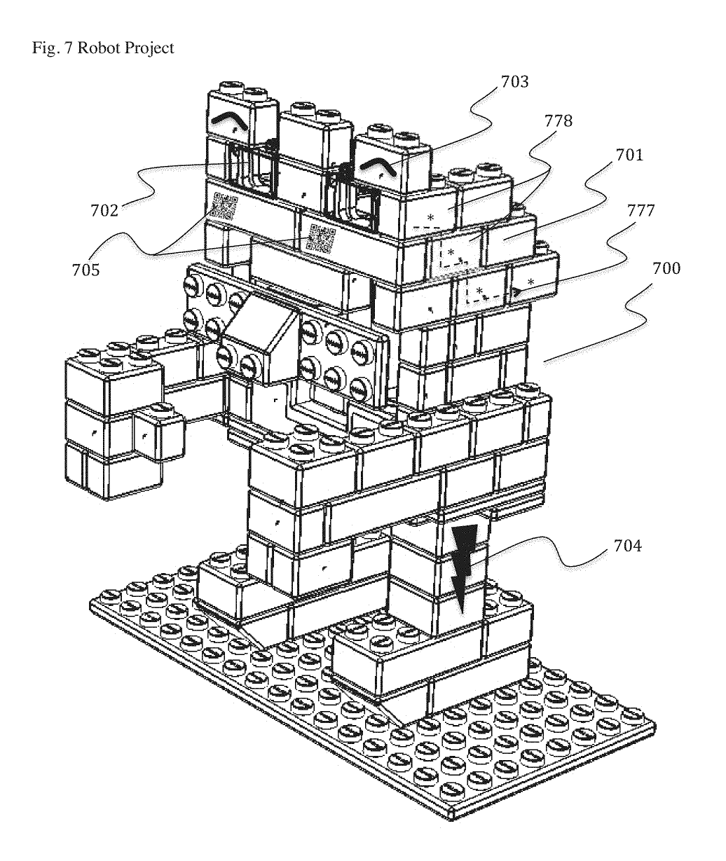

Referring first to FIG. 1, in an embodiment, a Novelette (or ‘story’) 105 is provided having at least one and preferably no more than thirty-one individual chapters 111. The chapters 111 of the Novelette 105 may be part of a line of physical product boxes 102, 201 which may be sold off the shelf 200 (FIG. 2) in any store. In one embodiment, the chapters 111 may be downloadable chapters 111 and the store an on-line store. The products 102, 201 (such as toy robots, toy animals, spaceships, etc) may also be sold by internet stores, or distributed to anyone for the purpose of educational motivation or just for fun. In an embodiment, each paragraph in a chapter 111 may end with an assigned project 333, for example the building of a robot toy object 700 similar to the one shown in FIG. 7. Each project 333 may be linked through an educational website 103 to real world educational details 110 about that project 333. For example, if the project 333 is to build the robot toy 700, the real-world education details 110 may be, for example, the science and physics behind how robots work and/or what robots are used for including for fun and in factories.

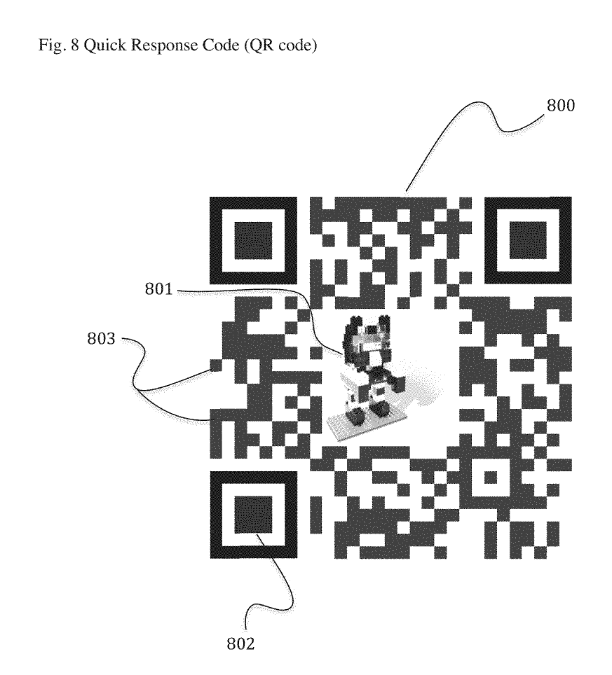

Each project 333 may also be linked through, for example, a QR code 800 (FIG. 8) to the educational website 103. This QR code 800 may be placed directly into the text of each chapter 111 for feedback as the story is being read. Included in each Product 102, 201 might also be a unique customer ID 104 number that, once entered into the required box on the educational website 103, such as Novelette Details & Links path 302, would bring the user (or “reader”) 444 to the correct Novelette 105 and the correct chapter 111 in that Novelette 105. At this point the user 444 may proceed to view educational details 110 about the project 333 and/or enter a contest 106 based on that Novelette 105.

If the user 444 elects to enter the contest 106, then the user 444 may decide to view or submit an entry 107, or to vote on an entry in the contest 106 when voting 108 is allowed. Winners of the contest 106 may be announced at an Awards Ceremony 109 when contest 106 is over. Under this system, a second Novelette 112 may be introduced. The educational website 103 may also have an information path 301 which may explain the contest 106 & awards, a path 303 to free courses, and/or a path 304 to special education areas such as poetry for example.

Inside each physical product box 102, 201 may be an alpha-numeric customer ID 104 number which may be permanently affixed to a crucial part of the physical product 102, 201 such as the battery holder. In particular, the product 102, 201 may not electrically function without this crucial part. When the alpha-numeric customer ID 104 number is entered into an input field 122 on the educational website 103, a key converter 401 built into the educational website 103 software may, in one embodiment, automatically convert lower case letters to upper case letters and may eliminate letters which look like numbers. For example the letter ‘S’ may be automatically made equal to the number ‘5’ and all letters ‘S’ may be removed from the ID numbers supplied. If the letter ‘S’ is typed it will become a ‘5’ during code entry into the educational website paths 301, 302 or will be simply rejected. This may help eliminate ID 104 entry errors.

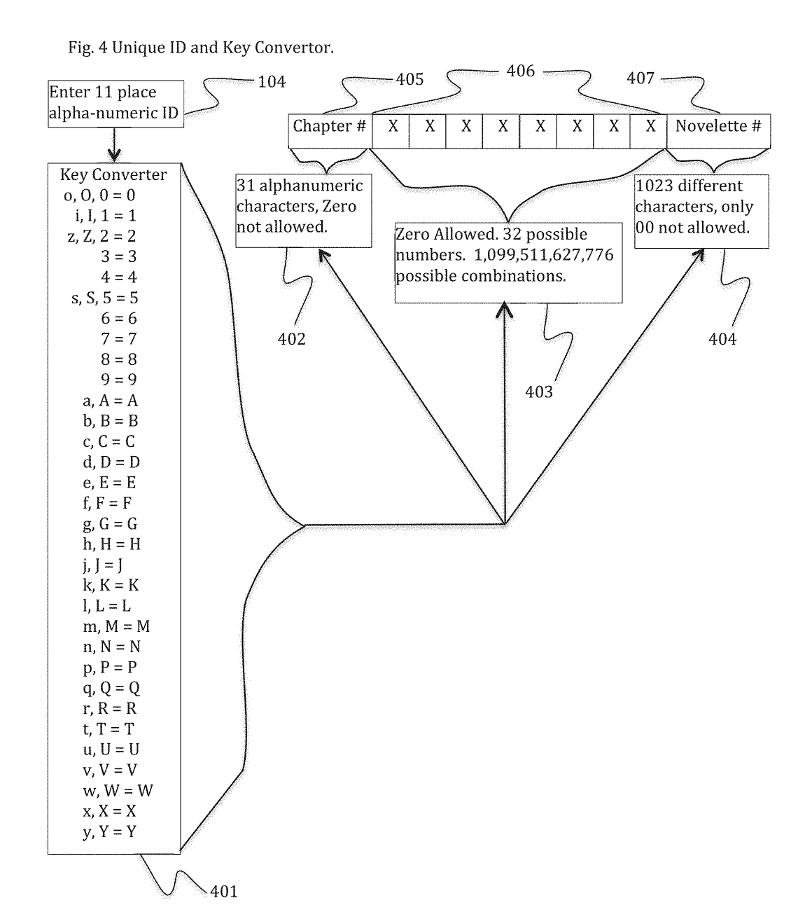

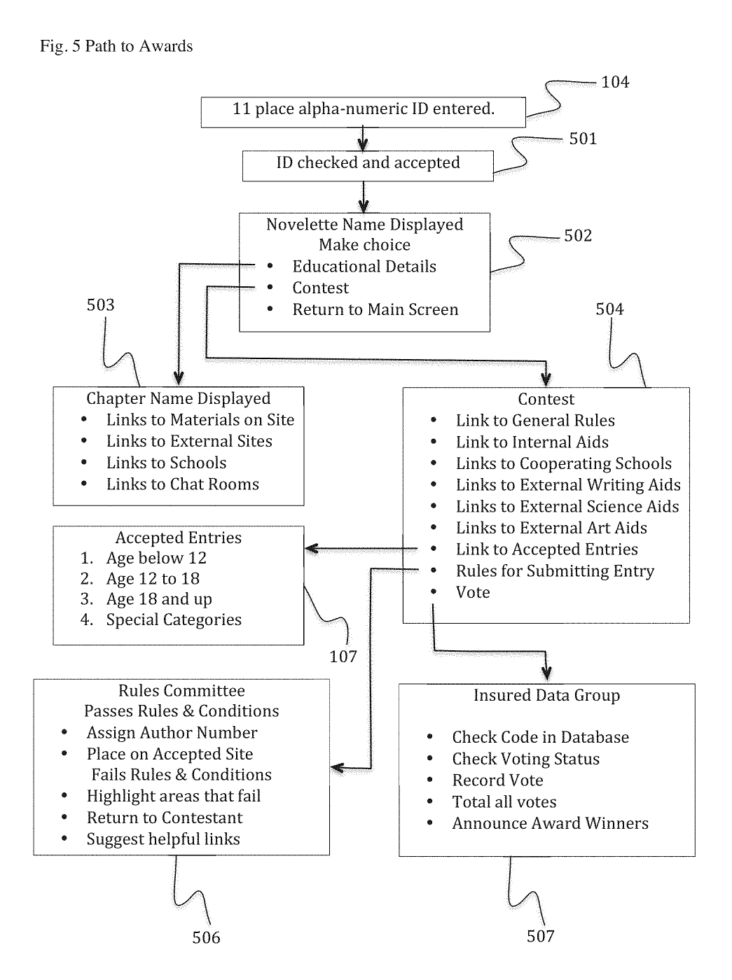

In one embodiment, the novelette 105 may have a first chapter 405. The customer ID 104 which represents the physical product 102, 201 (and comes with the product 102, 201) may contain a chapter 405 in the novelette 105. In an embodiment, there may be, for example, only thirty-one alpha-numeric characters 402 possible per each chapter 405. Different alpha-numeric characters 405 are shown in FIG. 4 Key Converter 401, therefore there can only be thirty-one chapters 111 for each novelette 105. Since zero is allowed, the next eight alpha-numeric characters 406 in the ID 104 produces a group of over a trillion combinations 403 as shown in FIG. 4. This group of eight characters 406 represents a voting 108 right in a contest 106 for the owner of the ID 104 that came with the product 102, 201. The last two characters 407 of the ID 104 represents the novelette 105 number. There are one thousand and twenty-three two alpha-numeric characters 404 possible different entries allowed for the last two characters 407 as shown in FIG. 4, thus there can only be 1023 different novelettes 105. Therefore, there are 31 times 1023, or 31,713, different products 102, 201 that can be sold. Each of these products can have an additional unique voting right 406 which creates 1,099,511,627,776 unique IDs 104 for that product. Therefore, over a trillion of each of the 31,713 products can be sold with unique ID codes for contest 106 and awards given in an Awards Ceremony 109. It should be understood that the number of “x” digits may be greater or fewer.

Each on the shelf physical product box 201 may contain artistic building blocks, electronic and science modules, assembly manuals, and an exciting chapter 111 in the novelette 105. This chapter 111 may contain a paragraph similar to the following;

“The day started like every other day as the early morning sun forced its way around the edge of the thick lightproof shade and chased the darkness from the room. Seymour could hear the ocean waves pounding the beach in the distance as he slowly tried to pry his eyes open for the first time. Suddenly the sound of the ocean's heartbeat was broken as RBN7's soft female voice announced ‘Good morning sir, it is 06:32 in the morning.’ Good Morning Robin′ Seymour said as he greeted his robot¹ friend.
To meet RBN7 build project 1.”

[symbol]

In an embodiment, the packaged physical product box 201 may come with the construction type elements. More specifically, in one embodiment, the construction type element may be a plurality of construction building blocks 701 needed to build the objects 700 described in the novelette 105. In an embodiment, instructions 555 may be provided to the user 444 to build the object 700. The building and/or modification of the objects 700 may promote education and entertainment in the Arts. In an embodiment, the instructions 555 may further provide for or require some artistic adaptation of the objects 700 by the individual user 444 by, for example, leaving some portions of the instructions 555 unspecified. As a result, a user 444 is required to personally adapt the objects 700 by utilizing some of their own creativity and imagination. Thus, no two finalized objects 700 would generally be forced to be identical.

Even further, the user 444 may be required to personally adapt the story itself in addition to or alternatively to personally adapting the objects 700 in the story. More specifically, in an embodiment, a user 444 may be required to individually write (or alter) a portion of the story himself/herself and submit the portion of the story to the website along with the submitted object 700 created by the user 444. This may be accomplished by, for example, leaving portions of the story blank which must be filled in by the user 444 prior to being submitted to the website. For example, the story may say, for example, the “The Robot's name is ______. ______traveled to the town of ______in order to find ______.” As a result, before a user 444 may submit a completed story to the website to participate in the contest, the user 444 must individually adapt at least a portion of the story by, for example, filling in blanks in the story. The written adaptation by the user 444 further provides a basis for other users 444 to vote on their favorite written and physical submission.

In an embodiment, other users 444 (or contestants) may vote not only on the best individually created objects 700 but also on the best adaptation of the story and further the best overall adaptation of both the story and the objects 700. In an embodiment, the adapted stories may be submitted electronically along with photos of the adapted objects 700. Even further, in one embodiment, the adaptation of the story and/or adaptation of the objects 700 is voted on by an independent judge (IE—someone who has not submitted his or her own adaption of the story to the website to participate in the contest).

Further, decorations may be included with the products 201 and may be applied by the user 444 to the building blocks 701 to create unique works of art. In one embodiment, water color paint 703 may be provided to decorate the blocks 701. Further, decals 704 may be provided to the user 444 to decorate the blocks 701. The created objects 700 may also be used to teach a scientific principle, such as electronics, by having conductive paths 777 made with conductive blocks 778 (FIG. 7) incorporated into the object 700 which make, for example, a robotic eyes 702 light up. The created objects 700 and building blocks 701 in each of the packaged products 201 may therein lead the user 444 to want to investigate the science associated with the object 700 on the educational website 103 in a section that contains educational details 110.

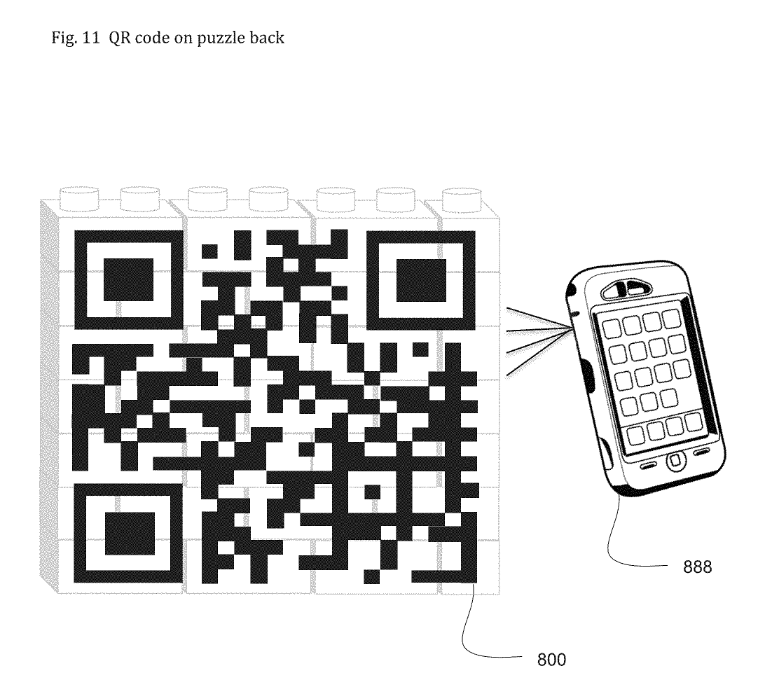

In an embodiment, the educational website 103 of the present system may contain external links 503 to a secondary website such as, for example, the official NASA website, which discusses robots in more detail and wherein the user 444 can supplement or obtain additional educational information related to the novelette 105. In an embodiment, there may also be external links to educational Internet sites such as stemrobotics.cs.pdx.edu. In either case, these external links are preferably qualified government or educational sites. Further, in an embodiment, the user 444 may choose to go directly to one of these external links while reading a paragraph (for example the paragraph shown above) by using a cell phone 888 (FIG. 11) or other hand held device equipped with the proper software to read the QR code 800 contained in the paragraph.

By making the word “robot” in the above paragraph the same color as the QR code 800 Foreground color 803 even young users 444 (or “readers”) may quickly grasp the connection. The footnote for the word “robot¹”, the “1”, at the bottom of the page may contain a bullet with the same color as the Inner Eye 802 color of the QR code 800 so as to make easy linking from the footnotes to the Internet site from which further educational information may be obtained. Even a picture of a robot 801 may be included in the QR code 800 to motivate the user 444 to further investigate this science or art. In an embodiment, the QR code 800 may even be placed on a module 705 to provide an Internet link which further defines the function of that module or safety features and other uses for that module.

Once a user 444 enters the educational website 103, and the ID 104 may be checked and accepted 501, other links 503 may also be presented after the Novelette 105 name is displayed 502. Instead of picking educational links 503, the user 444 may choose to enter a contest 106 in an attempt to win an award. Contest details 504 like General Rules, Internal Aids, Cooperating Schools, Links to External Writing Aids, Links to External Science Aids, Links to External Art Aids and even a website to show Accepted Entries from those submitted 107 may be displayed when the contest 106 is selected. All Accepted Entries from those submitted 107 may be broken into Categories of Age and Special for handicapped, challenged, or special institutions.

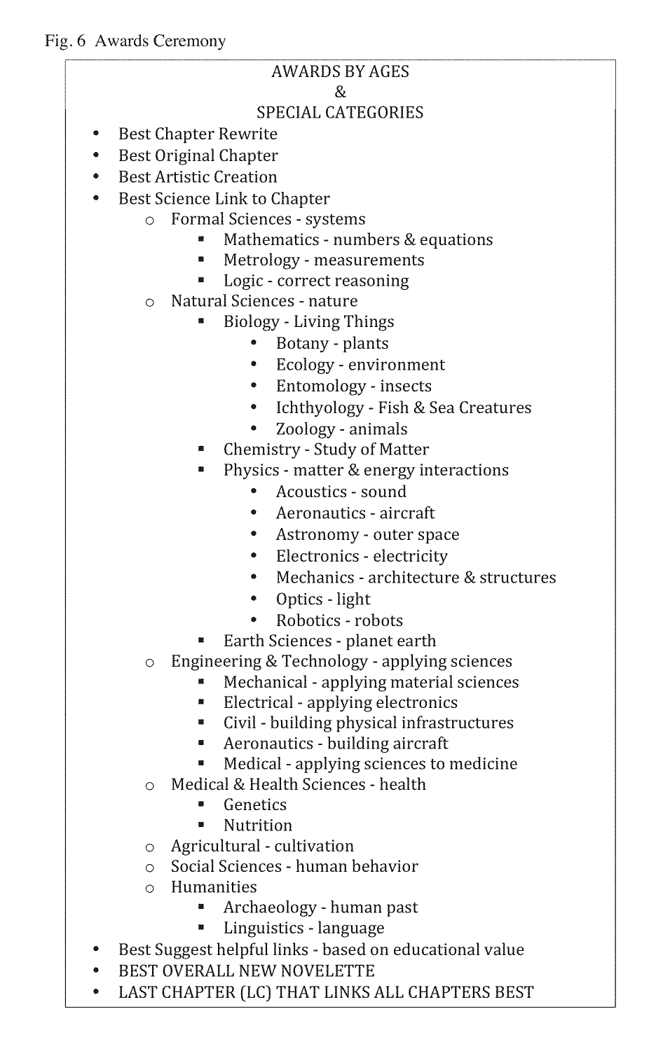

In an embodiment, a user 444 may also choose to submit an entry 107 into the contest 106. A Rules Committee 506 checks to make sure each submission passes all the rules and conditions before the committee assigns an Author Number and places the entry on the Accepted site of entries submitted 107. If the submission fails any rules and conditions the committee will highlight the area that fails and return entry to contestant with suggestions to helpful links. Contest voting 108 security and data is held and monitored by a third party according to the rules shown in Insured Data Group 507. The contest winners could receive their awards at an Awards Ceremony 109. Some suggested awards and possible categories are shown in FIG. 6.

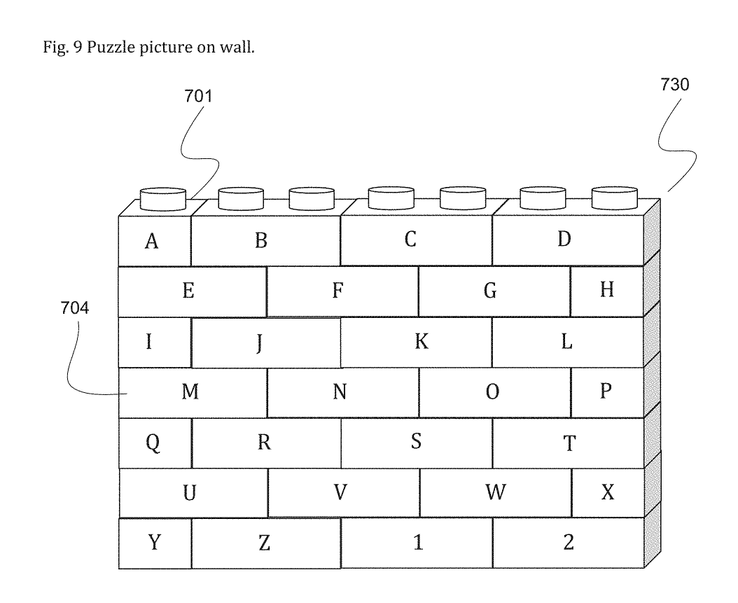

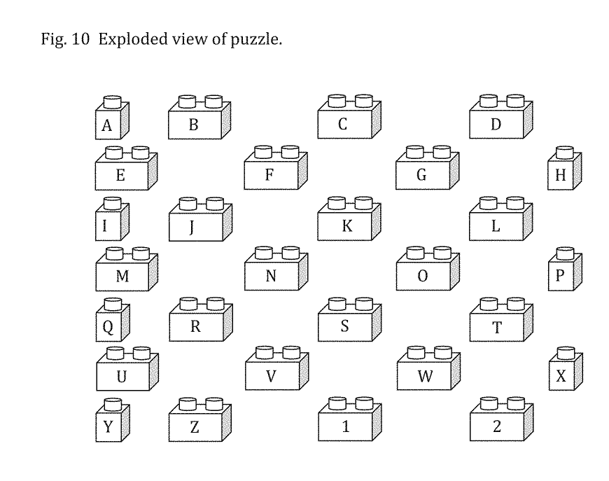

Referring now to FIGS. 9-11, in an embodiment, the plurality of building blocks 701 may be used to create, for example, a wall 730 as opposed to a robot. The wall (or building) may be described in one of the chapters 111 and may be required to be built per the instructions 555. Accordingly, the objects 700 created from the building blocks 701 are not limited to animals, robots, etc, but may be any variety of things which may interact with other objects 700 created. In one embodiment, as illustrated in FIG. 11, upon building an object 700 (in this case a wall) the object 700 may display a functional QR code 800, once completed, which interacts with the Internet website 103. In an embodiment, the QR Code may not be functional without proper assembly of the object 700 (illustrated as the back of a wall in FIG. 11) as an inactive portion of the QR Code may be located on multiple individual blocks which only renders the QR Code readable when properly assembled. FIGS. 9 and 10 illustrate the front of the blocks (which, in this case lack the partial image of the QR Code), wherein the back of the blocks may have the partial image of the QR Code.

In yet another embodiment, a functional QR Code may be formed by assembling the plurality of blocks in one arrangement while assembling the exact same blocks in an alternative arrangement may form a second distinct, yet also functional, second QR Code. As a result, multiple different functional QR Codes may be created out of the exact same blocks depending on the arrangement of the blocks selected by the user 444. Still further, in an embodiment, a non-functional QR Code may be created if the plurality of blocks are not assembled in one of a selected acceptable arrangement. Even further, the functional QR Code may be assembled from a plurality of individual two dimensional playing cards (not shown), as opposed to being assembled out of a plurality of blocks.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1) A system for teaching an individual comprising the steps of:
providing a story in electronic or book form to an individual;
providing a plurality of building blocks to the individual;
providing a website associated with the story;
providing instructions to the individual which allow the individual to physically build an object out of the plurality of building blocks;
allowing the individual to submit his/her individually created object to the website;
publicly displaying the individually created object of the individual on the website wherein the individually created object is viewable by a plurality of contestants; and
providing a voting system forming a contest on the website wherein the plurality of contestants may vote on the individually created object of the individual.

2) The system of teaching of claim 1 further comprising the step of:
forcing the individual to personally adapt the object by providing less than full instructions for creating the object to the individual.

3) The system of teaching of claim 1 wherein the object is submitted electronically to the website.

4) The system of teaching of claim 1 further comprising the step of:
providing a plurality of electronic paths connected to or within the plurality of building blocks wherein the electronic paths are made from multiple electrical components.

5) The system of teaching of claim 4 wherein the plurality of electronic paths connected to or within the plurality of building blocks are capable of allowing sound and/or movement to the plurality of building blocks.

6) The system of teaching of claim 1 further comprising the step of:
providing an award to the individual based on the voting results of the contest.

7) The system of teaching of claim 1 further comprising the step of:
providing a plurality various computer codes to the individual along with the story wherein the plurality of various computer codes are capable of allowing access and interaction between the individual and the website.

8) The system of teaching of claim 7 wherein the plurality of various computer codes are a plurality of alpha-numeric characters forming a unique customer ID wherein the unique customer ID is assigned to a chapter of the story.

9) The system of teaching of claim 7 wherein the various computer codes are individually unique computer customer ID such that no two computer codes are the same in the system.

10) The system of teaching of claim 9 wherein the individual may vote in the contest by entering his/her unique computer customer ID into the website.

11) The system of teaching of claim 10 wherein the unique computer customer ID may only be used to vote once.

12) The system of teaching of claim 1 further comprising the step of:
dividing the story into a plurality of individual chapters.

13) The system of teaching of claim 12 wherein there are thirty-one possible chapters of the story.

14) An educational method for teaching students utilizing a contest, the method comprising the steps of:
providing a story in electronic or book form to a plurality of individuals;
providing a website associated with the story;
providing instructions to the plurality of individuals requiring each of the plurality of individuals to individually adapt the story based on their own personal interest;
allowing the plurality of individuals to individually submit his/her adaptation of the story to the website;
publically displaying the website; and
providing a voting system wherein each of the plurality of individuals adaptation of the story is voted on by others.

15) The educational method for teaching students utilizing a contest of claim 14 wherein the plurality of individuals unique adaptation of the story is voted on by other of the plurality of individuals which also submit an adaptation of the story to the website and participate in the contest.

16) The educational method for teaching students utilizing a contest of claim 14 wherein the plurality of individuals unique adaptation of the story is voted on by independent judges who do not submit an adaptation of the story to the website for the contest.

17) The educational method for teaching students utilizing a contest of claim 14 wherein the plurality of students adapts the story by filling in blanks in the story.

18) The educational method for teaching students utilizing a contest of claim 14 further comprising the step of:
awarding at least one prize based on voting results of the contest.

19) A system of providing a QR Code comprising:
providing a plurality of building blocks;
providing a portion of a QR code on each of the plurality of building blocks; and
wherein the QR Code becomes readable and functionable by a QR Code reader only upon a proper assembly of the plurality of building blocks in the proper order.

20) The system of providing a QR Code of claim 19 wherein a non-functional QR Code is created by an incorrect arrangement assembly of the plurality of building blocks.
